(19) United States
(12) Patent Application Publication
(10) Pub. No.: US 2012/0139295 A1
(43) Pub. Date: Jun. 7, 2012

(54) Supporting structure with a plug-in connection between two intersecting profile parts

(76) Inventor: Andreas Huepperling, Grefrath (DE)

(21) Appl. No.: 12/958,458

(22) Filed: Dec. 2, 2010

(51) Int. Cl. B62D 25/06

(52) U.S. Cl. 296/193.06

(57) ABSTRACT

A supporting structure with two intersecting profile parts is provided. Both profile parts are each designed as a Z-profile with a web and two flanges bent out of a plane of the web along bending lines, and, at an intersecting point, have corresponding recesses for a plug-in connection of the profile parts. A first profile part has, in a lower flange, a substantially right-angled recess which is adjoined by a vertically running slot in the web. A second profile part has a recess which extends from the upper flange of the second profile part into the web and ends at a distance from the bending line between the web and the lower flange of the second profile part. The distance is matched to the vertical extent of the slot of the first profile part such that a sliding fit is formed between the first and the second profile part.

### FIELD OF INVENTION

The invention relates to a supporting structure with at least two intersecting profile parts, wherein the profile parts are each designed as a Z profile with a web and two flanges bent out of a plane of the web along bending lines, and, at least one intersecting point, have corresponding recesses for a plug-in connection of the profile parts.

### BACKGROUND OF INVENTION

A supporting structure of this type is known from DE 199 14 164 A1. In particular, provision is made there for a recess to be formed at the at least one intersecting point in the transition region from the web to the upper flange of a first profile part in order to form a lug, wherein a front end of the lug extends parallel at least in regions to a joining edge of a flange of a second profile part. The corresponding cutouts here in the two profile parts are of identical and substantially chair-shaped design. The flange lug discussed is located in a bending radius region, i.e. in a transition region between the web and bent flange. The formation of said flange lug is made possible by a certain procedure, wherein, in a first machining step, the dumbbell-shaped cutout for the flange lug has to be introduced in the flat state of the uncoiled sheet-metal blank associated with the profile part and, in a second machining state, the flange lug is then automatically formed by means of deformation by means of the defined position within the sheet-metal blank. The use of the plug-in technique is expressly restricted at this juncture only to this procedure. Alternative manufacturing methods for producing profile parts, for example roll forming, are not given consideration here. The preset flange lug is therefore essential in the solution to provide a plug-in connection between two intersecting profile parts, but said flange lug involves the disadvantages discussed. Added thereto is also the fact that the type of plug-in connection here is used exclusively only if the first profile part with the flange lug has a rectilinear profile contour. Plug-in connections between two profile parts, in which the first profile part has an arcuate profile contour, are therefore ruled out since, firstly, the flange lug cannot be formed after the profile-bending operation and, secondly, the procedure for curved parts requires a homogeneous profile cross section and therefore the cutouts have to be introduced after the profile-bending operation.

The second essential aspect in the solution for the plug-in connection, to which the invention relates, is that the two profile parts which intersect via the plug-in connection can be joined optionally not only by means of classic gas metal arc welding methods but also on the basis of the low-gap formation of the joining edges by means of low-distortion laser welding methods. This is unambiguously ensured specifically by the design of the flange lug for the plug-in connection of rectilinear profile parts.

### SUMMARY OF INVENTION

An object of the invention is to specify a supporting structure with at least two intersecting profile parts, in which the profile parts can be both rectilinear and arcuate and can be joined by means of gas metal arc welding or laser welding, depending on requirements, but, given a defined procedure for the production of the profile parts, said type of procedure essentially does not need to be changed.

This object is achieved with the supporting structure mentioned at the beginning in that a first profile part has, in the lower flange thereof, a substantially right-angled recess which is adjoined by a vertically running slot in the web, and a second a profile part has a recess which extends from the upper flange of said profile part into the web and ends at a distance from the bending line between the web and the lower flange of the second profile part, which distance is matched to the vertical extent of the slot of the first profile part such that a sliding fit is formed between the first and the second profile part.

The sliding fit which is realized in this manner makes it possible for profile parts to be connected to each other by a plug-in connection in a tolerance-compensating manner in one direction and at the same time fixing the position in another direction substantially irrespective of whether said profile parts are rectilinear or arcuate. The sliding fit here is provided essentially between the two webs of the first and of the second profile part. Depending on the application, the basic principle of the plug-in connection between the first and the second profile part applies to a plug-in connection of at least
two rectilinear profile parts for a flat side wall framework, roof framework, underframe framework and end wall/rear wall framework,
a rectilinear and a curved profile for a side wall framework and roof framework which is arcuate, for example, in a uniaxial manner (barrel-shaped), and
two curved profiles for a spatially arcuate vehicle head framework,
   which are joined by means of classic welding methods.

The first profile part can have, over a section of the bending line between the web thereof and the upper flange thereof, a cutout for forming a square butt joint with a protruding section of the upper flange of the second profile part, this being able to be carried out by a small adaptation of the component geometry of the profile part in question without the defined procedure for the production of the profile parts having to be changed. In this embodiment, the laser welding can be used as the joining method since the two intersecting profile parts can fit together well. In this case, a joining edge of the cutout of the first profile part is always located behind a transition region/runout of the bending radius between the web and upper flange of the first profile part.

Since the joining edge is located behind the transition region and exclusively in the flange region, in the case of rectilinear profiles there is the option of choosing between introducing all of the recesses in the flat state, for example by means of two-dimensional laser cutting and subsequent deforming by means of edge bending (edge profiles) and introducing all of the recesses after deformation to form the profile (edge profile or roll-formed parts) by means of three-dimensional laser cutting as required for arcuate parts which, after the deformation to form the rectilinear profile, proceed through an additional deformation process by means of profile bending.

The recess in the second profile part can have a web lug which is designed to form a T joint with the upper flange of the first profile part. After the first and second profile parts have been plugged together, a web lug of this type bears against the lower side of the upper flange of the first profile part, thus resulting in a vertical stop for the first profile part. The ensuing T joint now creates the option of providing a fixed connection of the T joint from the lower side of the connection by means of a fillet weld (gas metal arc welding method and laser welding method) or from the more easily accessible upper side by means of a stitch weld (laser welding).

The recess in the second profile part can have a vertically running web lug which, in the plugged-together state of the profile parts, projects into an associated cutout in the upper flange of the first profile part. In this case, the web lug can be extended in relation to the previously explained embodiment by at least a material thickness of the upper flange of the first profile part such that said web lug dips through the upper flange.

In the web lug region, the upper flange obtains an additional cutout in the form of a slot which is slightly wider than the material thickness of the web lug. This creates a further plug-in option between the two profile parts and at the same time creates better visibility and accessibility for a connection by means of welding methods (laser welding, square butt weld at the corner joint with two joining edges in the slot region).

In general, the two profile parts are welded in the region of the bending line between the web and the upper flange of the first profile part to the adjacent region of the upper flange of the second profile part, specifically, depending in each case on the size of the gap in between, by means of laser welding or classic welding methods.

According to a preferred embodiment, the two profile parts are of identical height.

### BRIEF DESCRIPTION OF THE DRAWINGS

Exemplary embodiments of the invention are explained in more detail below with reference to the drawing, in which functionally similar components are denoted by the same reference numbers. In the drawing:

FIG. 1 shows a perspective view of a plug-in connection of two profile parts in an assembled state according to a first embodiment,

FIG. 2 shows a perspective view of the plug-in connection from FIG. 1 in an exploded state,

FIG. 3 shows a top view of the plug-in connection from FIG. 1,

FIG. 4 shows a sectional illustration of the plug-in connection from FIG. 1 along a plane AA from FIG. 3,

FIG. 5 shows a sectional illustration of the plug-in connection from FIG. 1 along a plane BB from FIG. 3,

FIG. 6 shows a developed view of a first profile part of the plug-in connection from FIG. 1,

FIG. 7 shows a developed view of a second profile part of the plug-in connection from FIG. 1,

FIG. 8 shows a perspective view of a plug-in connection of two profile parts in an assembled state for a supporting structure according to a second embodiment,

FIG. 9 shows a perspective view of the plug-in connection from FIG. 8 in an exploded state,

FIG. 10 shows a top view of the plug-in connection from FIG. 8,

FIG. 11 shows a sectional illustration of the plug-in connection from FIG. 8 along a plane A-A from FIG. 10,

FIG. 12 shows a sectional illustration of the plug-in connection from FIG. 8 along a plane A-A from FIG. 10 with an illustration of installation steps for a plugging-together operation,

FIG. 13 shows a sectional illustration of the plug-in connection from FIG. 8 along a plane B-B from FIG. 10,

FIG. 14 shows a developed view of a first profile part of the plug-in connection from FIG. 8,

FIG. 15 shows a developed view of a second profile part of the plug-in connection from FIG. 8,

FIG. 16 shows a perspective view of a plug-in connection of two profile parts in the assembled state for a supporting structure according to a third embodiment,

FIG. 17 shows a perspective view of the plug-in connection from FIG. 16 in an exploded state,

FIG. 18 shows a top view of the plug-in connection from FIG. 16,

FIG. 19 shows a sectional illustration of the plug-in connection from FIG. 16 along a plane A-A from FIG. 18,

FIG. 20 shows a sectional illustration of the plug-in connection from FIG. 16 along a plane B-B from FIG. 18,

FIG. 21 shows a developed view of a first profile part of the plug-in connection from FIG. 16,

FIG. 22 shows a perspective view of a plug-in connection of two profile parts in the assembled state for a supporting structure according to a fourth embodiment,

FIG. 23 shows a perspective view of the plug-in connection from FIG. 22 in an exploded state,

FIG. 24 shows a top view of the plug-in connection from FIG. 22,

FIG. 25 shows a sectional illustration of the plug-in connection from FIG. 22 along a plane A-A from FIG. 24,

FIG. 26 shows a sectional illustration of the plug-in connection from FIG. 22 along a plane B-B from FIG. 24,

FIG. 27 shows an illustration of a detail X from FIG. 26 to explain a welded connection,

FIG. 28 shows an illustration of the detail X from FIG. 26 to explain a different welded connection,

FIG. 29 shows a developed view of a second profile part of the plug-in connection from FIG. 22,

FIG. 30 shows a perspective view of a plug-in connection of two profile parts in an assembled state for a supporting structure according to a fifth embodiment,

FIG. 31 shows a perspective view of the plug-in connection from FIG. 30 in an exploded state,

FIG. 32 shows a top view of the plug-in connection from FIG. 30,

FIG. 33 shows a sectional illustration of the plug-in connection from FIG. 30 along a plane A-A from FIG. 32,

FIG. 34 shows a sectional illustration of the plug-in connection from FIG. 30 along a plane B-B from FIG. 32,

FIG. 35 shows a view of a detail Y from FIG. 34,

FIG. 36 shows a developed view of a first profile part of the plug-in connection from FIG. 30,

FIG. 37 shows a developed view of a second profile part of the plug-in connection from FIG. 30.

### DETAILED DESCRIPTION OF INVENTION

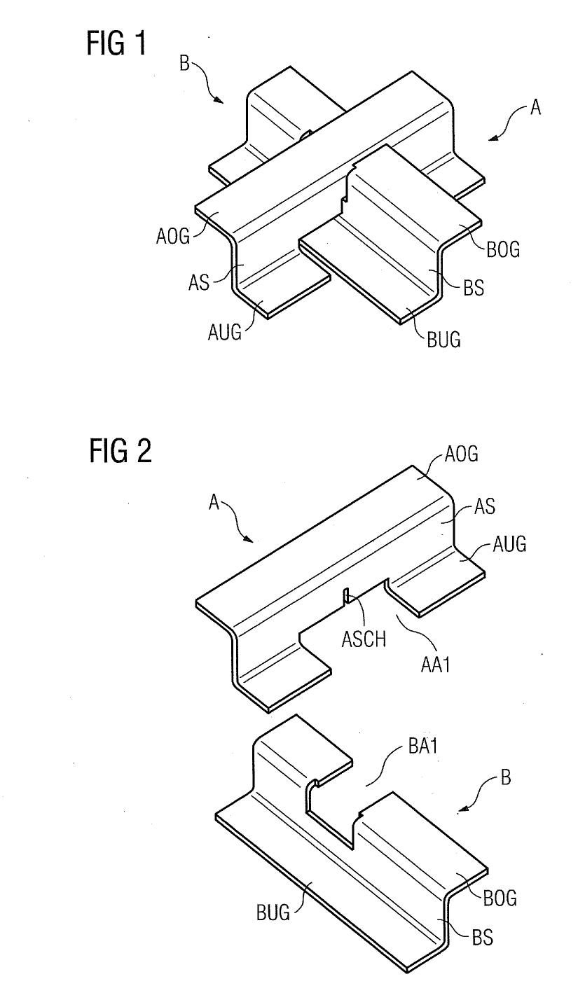

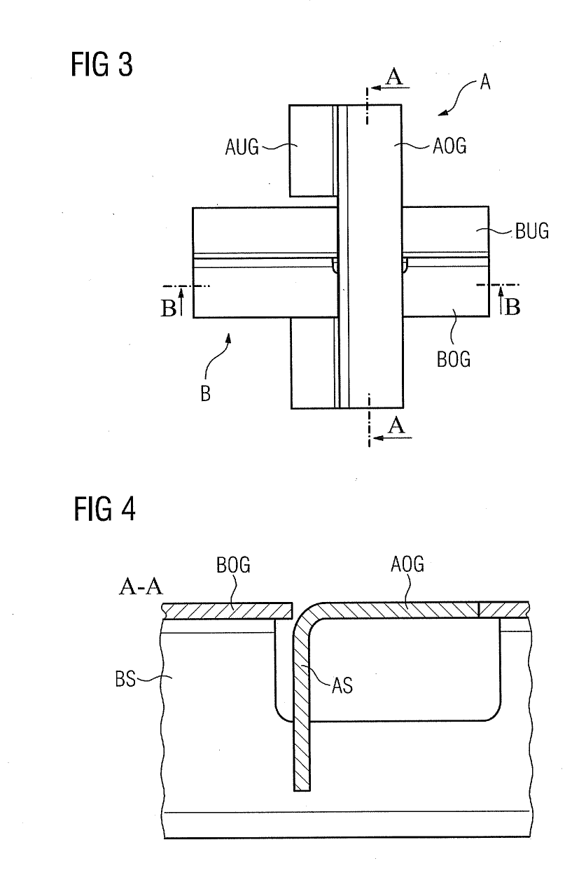

A first embodiment of a plug-in connection between two profile parts is explained with reference to FIGS. 1 to 7. The plug-in connection is formed from a first profile part A and a second profile part B which are of identical height and are used for the construction of supporting structures, such as, for example, a side wall framework, roof framework, underframe framework and end wall/rear wall framework of a rail vehicle. In this case, the profile parts A, B are rectilinear. The various embodiments of the invention are also explained below with reference to rectilinear profile parts. Said explanations here are similarly valid for plug-in connections between a rectilinear and a curved profile, as occur, for example, in side wall frameworks and roof frameworks which are arcuate in a uni-axial manner, but also in the case of two curved profiles for a spatially arcuate vehicle head framework.

Both profile parts A, B are each designed as a Z profile with a web AS, BS and two flanges AOG, AUG, BOG, BUG bent out of a plane of the web AS, BS along bending lines. At an intersecting point between the two profile parts A, B, respective recesses AA1, BA1 are provided for a plug-in connection of the profile parts.

The recess AA1 of the first profile part A is provided in the lower flange AUG thereof and has a substantially right-angled shape. The recess AA1 of the first profile part A is adjoined by a vertically running slot ASCH which is arranged approximately centrally in relation to the recess AA1 and runs out therein.

The second profile part B is distinguished in that the recess BA1 extends from the upper flange BOG of said profile part into the web BS and ends at a distance from the bending line between the web BS and the lower flange BUG of the second profile part B, which distance is matched to the vertical extent of the slot ASCH of the first profile part A. As is clear particularly from FIG. 4, this brings about a sliding fit between the two profile parts A, B.

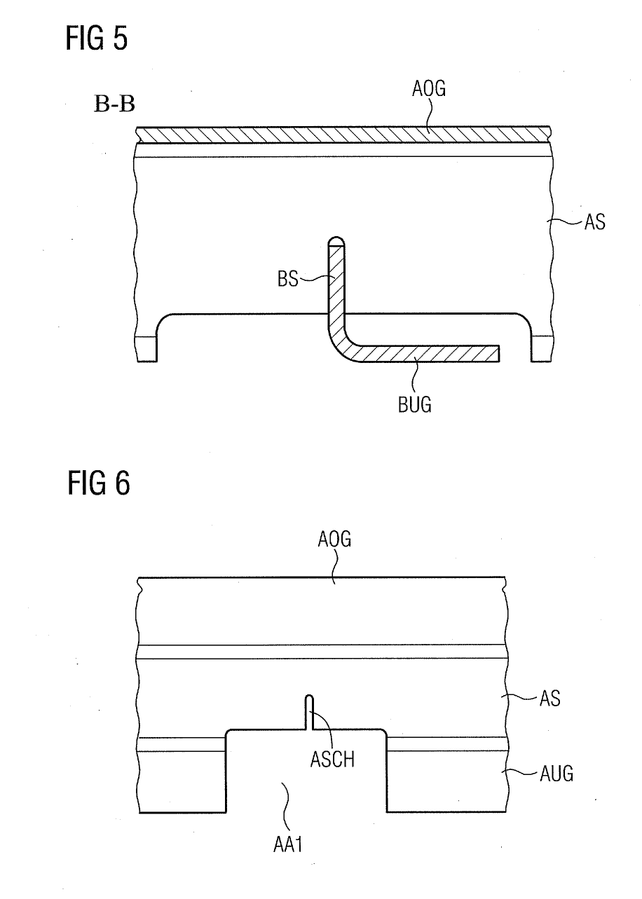

In the assembled state of the plug-in connection according to FIGS. 1, 3, 4, the upper flange AUG of the first profile part A is aligned with the upper flange BUG of the second profile part B while the web BS of the second profile part B engages in the slot ASCH for the purpose of positioning and guiding the sliding fit. This is clear particularly from FIG. 5.

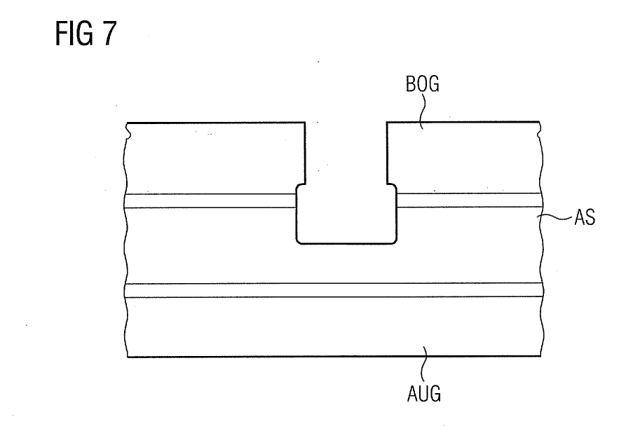

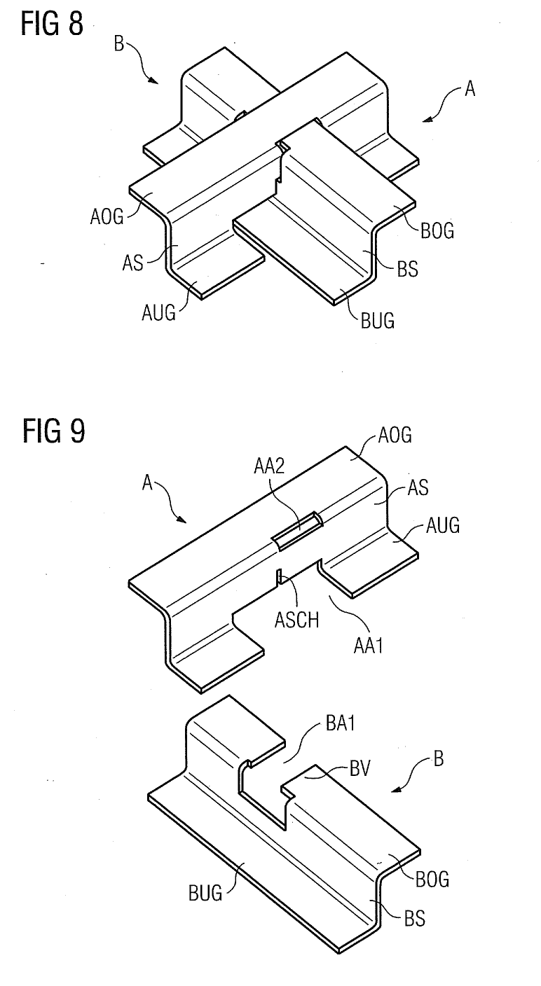

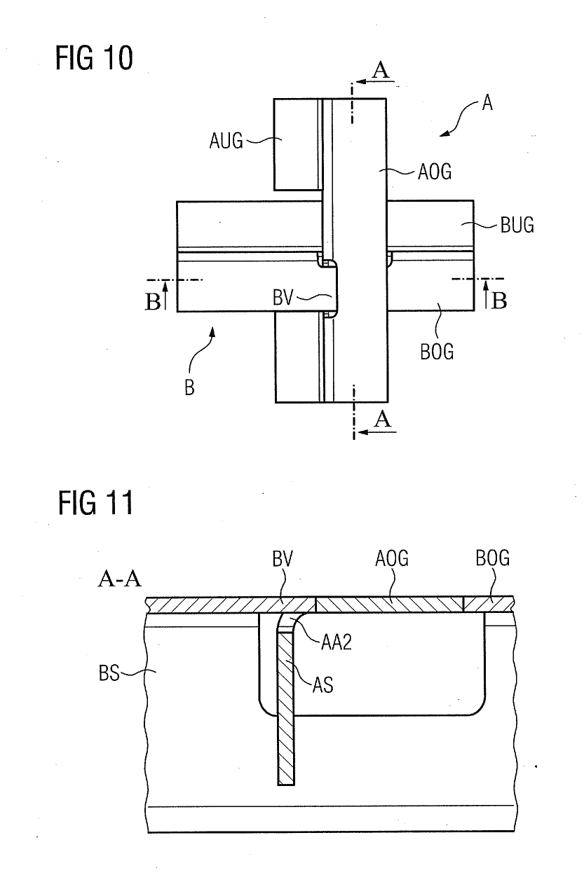

FIGS. 6 and 7 show the extents of the recesses AA1 and BA1 in more detail. It is clear that the recesses AA1, BA1 each extend beyond the adjacent bending line BL as far as the web AS, BS.

The first embodiment of profile parts A, B for constructing a supporting structure by means of plug-in connections is suitable for classic welding methods, such as gas metal arc welding methods. In this case, the joining edge is located behind the transition region between the web AS and the upper flange AOG and exclusively in the region of the upper flange AOG such that, in the case of rectilinear profile parts, there is the option of choosing between introducing all of the recesses in the flat state, for example by means of 2D laser cutting and subsequent deformation by means of edge bending (edge profiles), and introducing all of the recesses after the deformation to form the profile (edge profiles or roll-formed parts) by means of 3D laser cutting.

The embodiment of a plug-in connection according to a second variant of the invention differs from the first embodiment explained above in that a cutout AA2 is provided along a section of the bending line of the first profile part A between the web AS and the upper flange AOG, said cutout extending in the longitudinal direction of the profile part A approximately from the slot ASCH as far as the boundary of the recess AA1 in the longitudinal direction of the lower flange AUG such that, in the assembled state, said cutout is aligned with the upper flange BOG of the second profile part B, thus resulting in a square butt joint. In this case, the recess BA1 of the second profile part B is not, as in the first embodiment, mirror-symmetrical with respect to a transverse plane of the profile part B. On the contrary, the upper flange BOG has a projecting section BV for interaction with the cutout AA2 of the first profile part A.

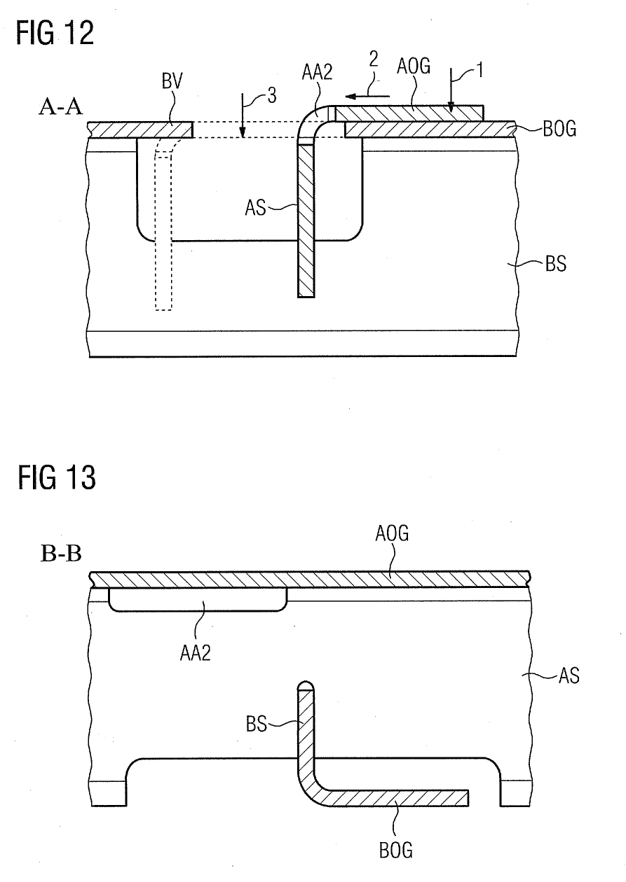

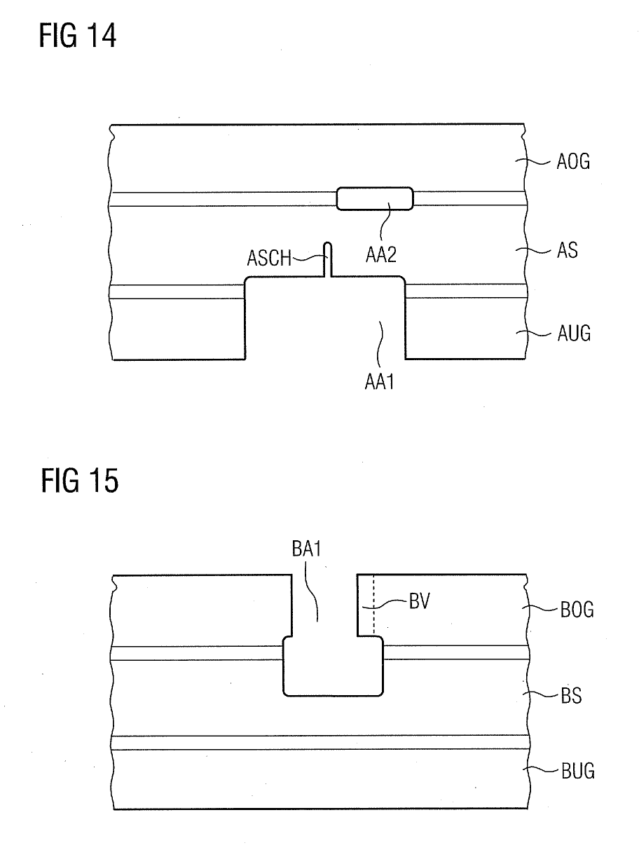

It is clear in particular from FIG. 11 that the two profile parts A, B can thereby be plugged together with little gap. Individual steps of the plugging-together operation, 1, 2, 3 using the sliding fit are illustrated in FIG. 12.

Owing to the narrow gaps between the upper flanges AOG, BOG of the two profile parts A, B, the embodiment according to the second variant permits joining by means of laser welding methods. In all of the embodiments of the invention, weld seams extend in accordance with the two joining edges in each case between the upper flanges AOG, BOG, i.e. in each case in the transverse direction of the profile B.

It is particular clearly apparent from FIG. 15 that the upper flange BOG of the second profile part B is extended on one side in comparison to the first embodiment.

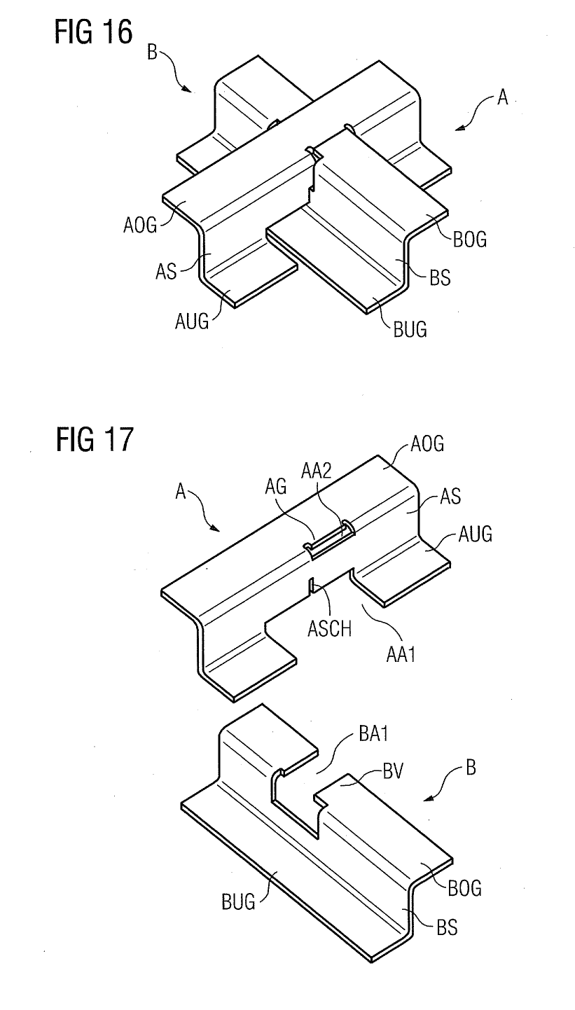

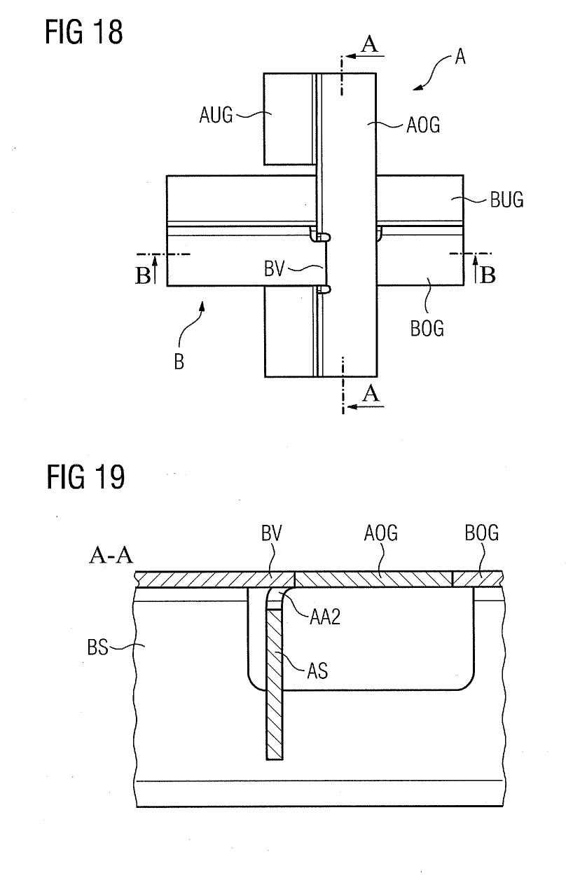

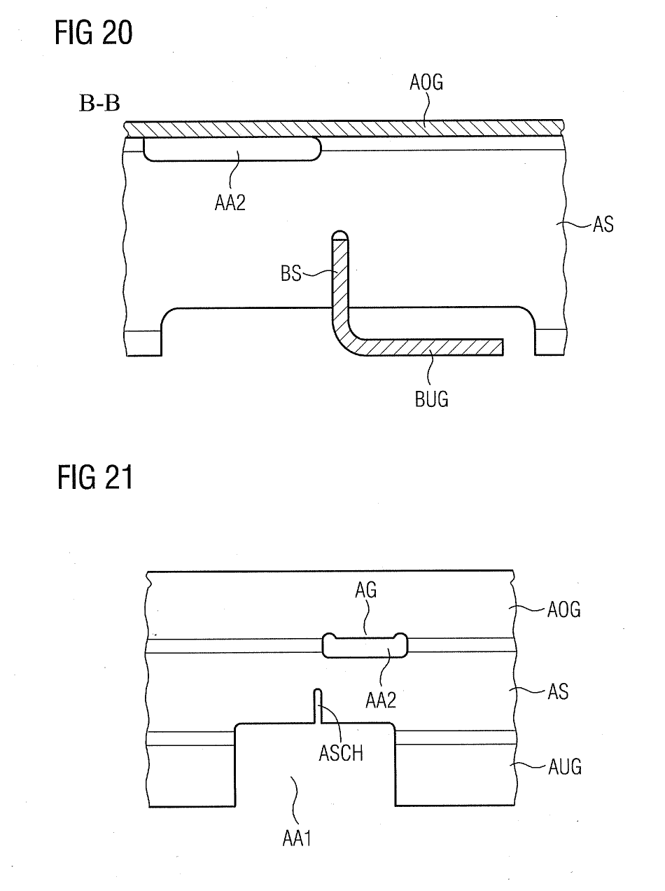

In a third embodiment according to FIGS. 16 to 21, the following difference over the previously explained, second embodiment arises in the design of the profile parts A, B: the recess AA2 has a flange lug AG which extends in the plane of the upper flange AOG in the direction of an adjacent section of the upper flange BOG of the second profile part B. A low-gap plug-in connection between the profile parts A, B is also provided in this embodiment, and therefore laser welding is possible.

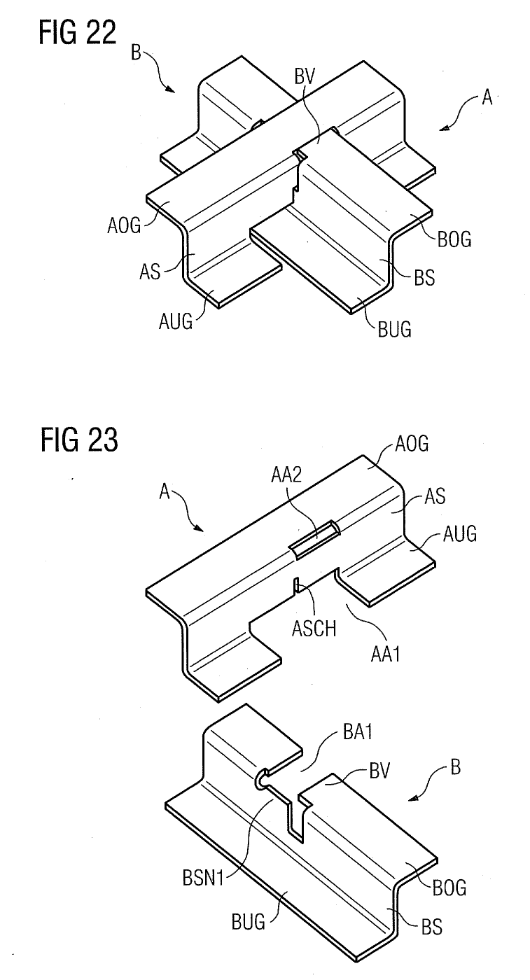

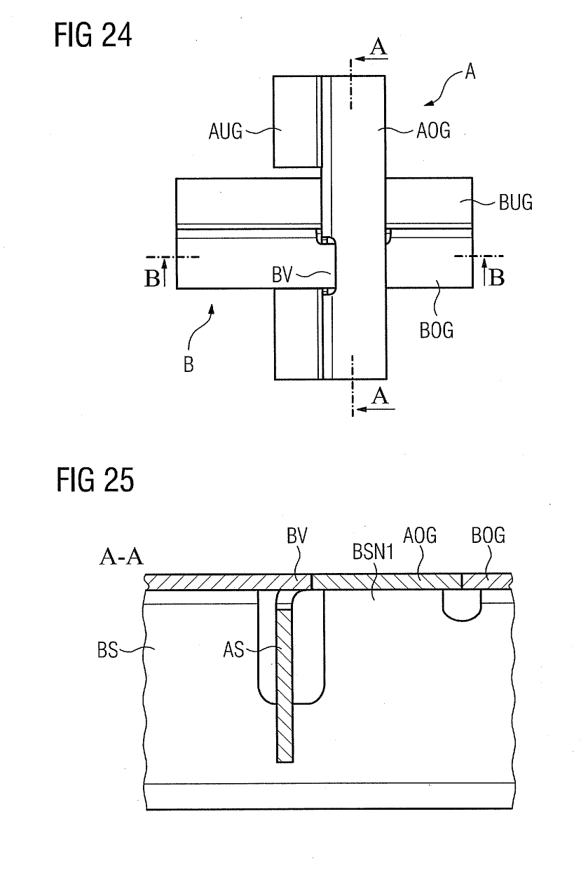

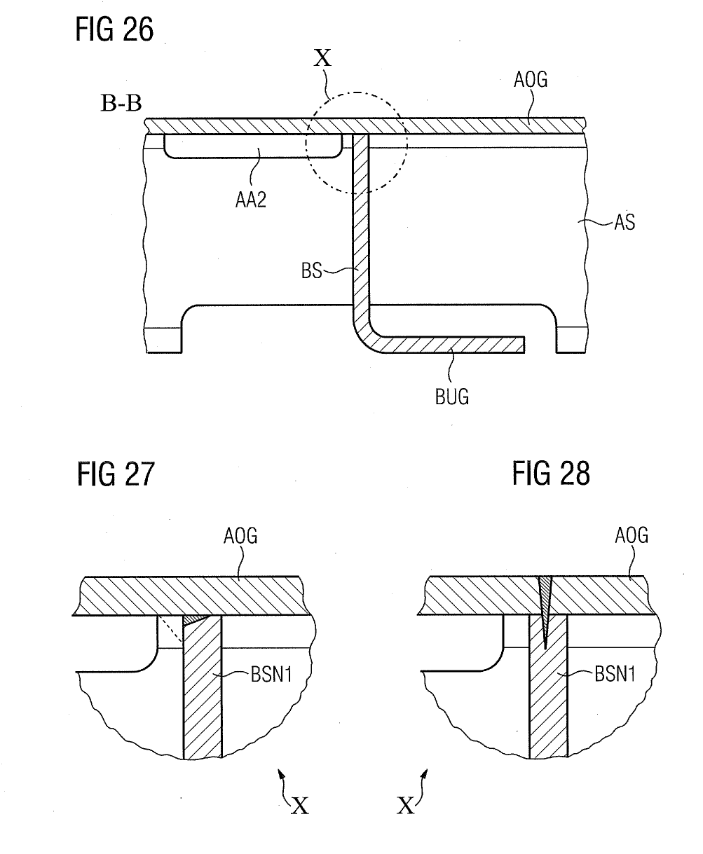

A fourth embodiment of the profile parts A, B for producing a plug-in connection is clear from FIGS. 22 to 29. The first profile part a here is structurally identical to the first profile part A according to the second embodiment explained above.

A web lug BSN1 is provided with respect to the second profile part B, said web lug being dimensioned in such a manner that, in the assembled state of the profile parts A, B, the web lug BSN1 enters into contact with the lower side of the upper flange AOG of the first profile part A, thus resulting in a T joint. The sliding fit is in principle retained in the fourth embodiment but is reduced with regard to its longitudinal extent.

FIGS. 27 and 28 show two different possibilities of creating a connection between the upper flange AOG of the first profile part A and the web lug BSN of the second profile part B by means of laser welding at the T joint. According to FIG. 27, a fillet weld is created at the T joint by means of gas metal arc welding or laser welding. By contrast, a stitch weld which can be realized exclusively by laser welding is shown at the T joint according to FIG. 28.

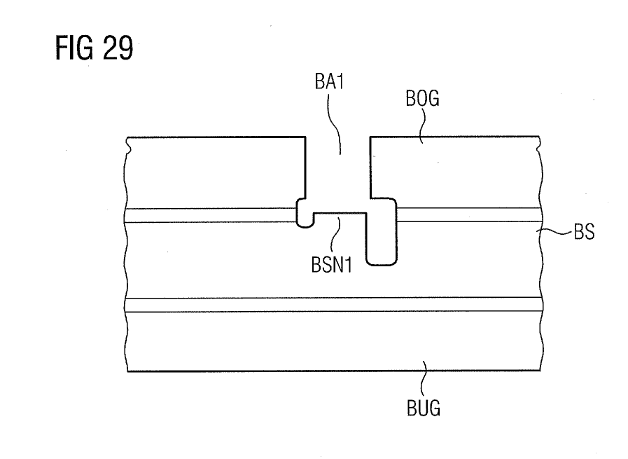

It is clear from FIG. 29 that the web lug BSN1, which can also be understood as being a stop edge, extends as far as the bending line between the upper flange BOG and web BS of the second profile part B.

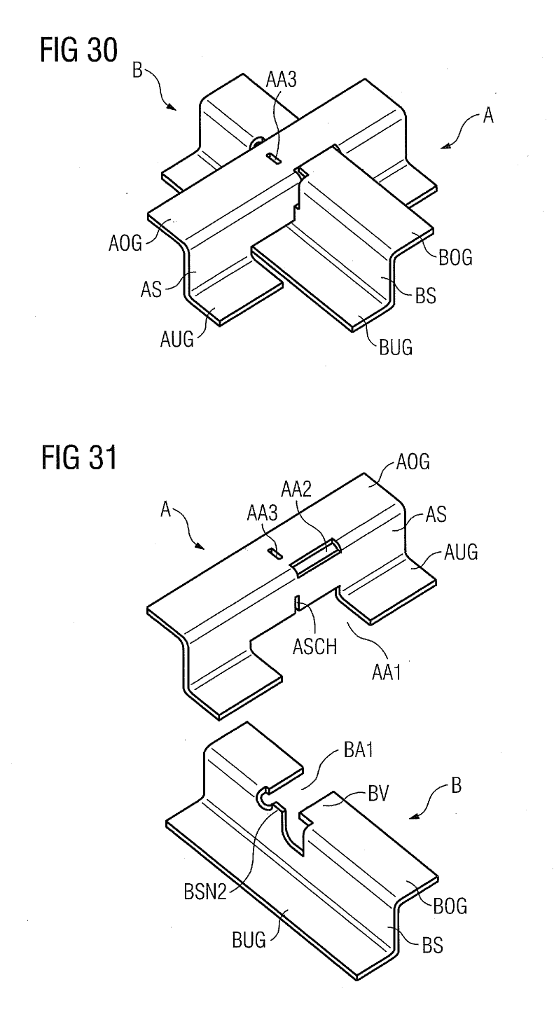

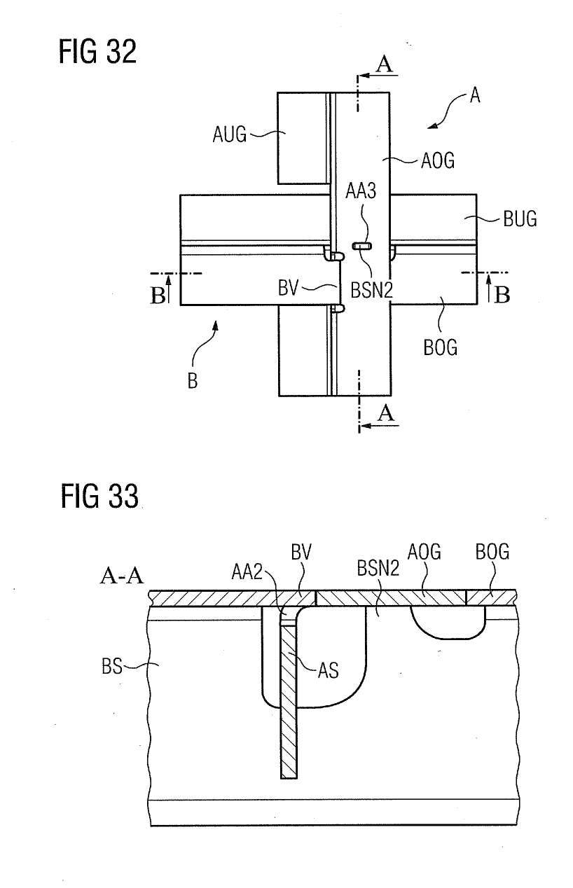

A fifth embodiment of a plug-in connection of the profile parts A, B is clear from FIGS. 30 to 37. The second embodiment of a plug-in connection, which has already been explained above, can be regarded as the starting point of the designs of the first and second profile part A, B, but both profile parts A, B are modified.

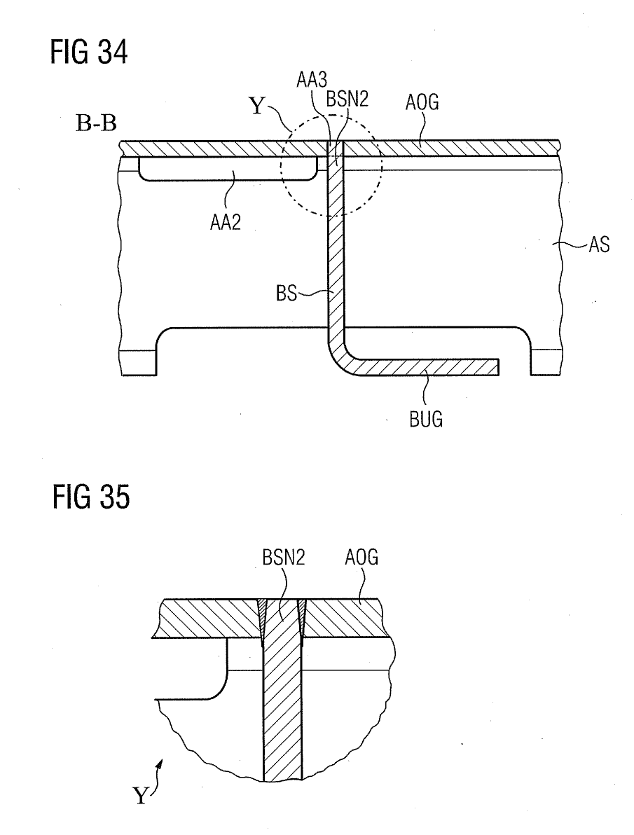

As can be seen, for example, from FIG. 34, the second profile part B has a web lug BSN2 which extends upwards to such an extent that, in the assembled state of the plug-in connection, said web lug projects into an associated cutout AA3 of the first profile part A. This results, as can be seen from FIG. 35, in mutually opposite square butt joints between the web lug BSN2 of the second profile part B and adjacent regions of the upper flange AOG of the first profile part A, at which a respective square butt weld produced by laser welding is provided.

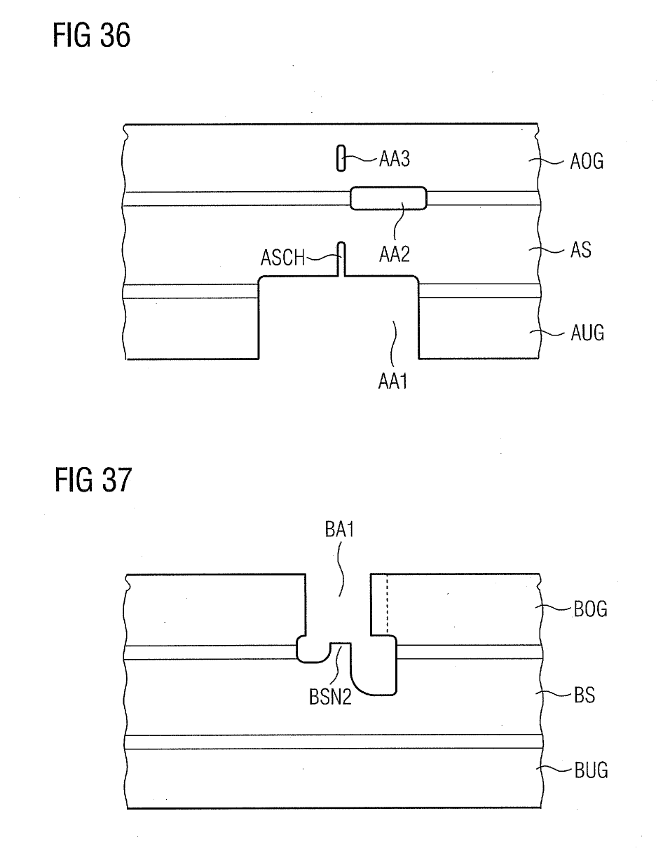

It follows that, as is clear from FIG. 36, the slot ASCH in the web AS and the cutout AA3 in the upper flange AOG of the first profile part lie in a plane.

It should be emphasized that, in a somewhat less optimum embodiment in the fifth variant, the recess AA2 may be omitted.

FIG. 37 illustrates in particular the extent of the plug-in web lug BSN2 in the direction of the interior of the recess BA1. Said extent is dimensioned in such a manner that, in the deformed state of the profile part B, the web lug BSN2 ends at an upper side of the upper flange AOG of the first profile part A. It goes without saying that, in a bending operation to deform the second profile part B, the plug-in web lug BSN2 is not included in the bending operation.

1.-13. (canceled)

14. A supporting structure, comprising:
two intersecting profile parts, wherein the profile parts are each designed as a Z-profile with a web and two flanges bent out of a plane of the web along bending lines, and, at an intersecting point, have corresponding recesses for a plug-in connection of the profile parts,
wherein a first profile part has, in a lower flange thereof, a substantially right-angled recess which is adjoined by a vertically running slot in the web, and
wherein a second profile part has a recess extending from an upper flange of the second profile part into the web and ending at a distance from a bending line between the web and the lower flange of the second profile part, and
wherein the distance is matched to a vertical extent of the slot of the first profile part such that a sliding fit is formed between the first and the second profile part.

15. The supporting structure as claimed in claim 14, wherein the first profile part includes, over a section of the bending line between the web and the upper flange, a cutout for forming a square butt joint with a protruding section of the upper flange of the second profile part.

16. The supporting structure as claimed in claim 15, wherein the cutout in the first profile part comprises a lug as an extension of the upper flange.

17. The supporting structure as claimed in claim 14, wherein the recess in the second profile part has a vertically running web lug which is designed to faun a T-joint with the upper flange of the first profile part.

18. The supporting structure as claimed in claim 14, wherein the recess in the second profile part has a vertically running web lug which, in the plugged-together state of the profile parts, projects into an associated cutout in the upper flange of the first profile part.

19. The supporting structure as claimed in claim 14, wherein the profile parts are welded in the region of the bending line between the web and the upper flange of the first profile part to the adjacent region of the upper flange of the second profile part.

20. The supporting structure as claimed in claim 17, wherein the vertical web lug of the second profile is welded to the upper flange of the first profile.

21. The supporting structure as claimed in claim 18, wherein the free end of the vertical web lug of the second profile part is welded to the upper flange of the first profile part.

22. The supporting structure as claimed in claim 14, wherein the profile parts are of identical height.

23. The supporting structure as claimed in claim 14, wherein the vertically running slot is arranged centrally in the web of the first profile part with respect to the adjacent recess in the first profile part.

24. The supporting structure as claimed in claim 14, wherein the two intersecting profile parts are rectilinear.

25. The supporting structure as claimed in claim 14, wherein the first profile part is rectilinear and the second profile part is curved.

26. The supporting structure as claimed in claim 14, wherein the two profile parts are curved.
